(19) United States
(12) Patent Application Publication
(10) Pub. No.: US 2021/0003708 A1
(43) Pub. Date: Jan. 7, 2021

(54) ACTUATION DEVICE WITH USER RECOGNITION

(71) Applicant: Geberit International AG, Jona (CH)

(72) Inventors: Roland OBERHOLZER, Uster (CH); Andreas Bitzer, Chur (CH); Hannes Merbold, Laax (CH)

(73) Assignee: Geberit International AG, Jona (CH)

(21) Appl. No.: 16/918,124

(22) Filed: Jul. 1, 2020

(30) Foreign Application Priority Data
Jul. 2, 2019 (EP) 19183896.0

(51) Int. Cl. G01S 17/48; E03D 5/10

(52) U.S. Cl. CPC G01S 17/48; E03D 5/105

(57) ABSTRACT

An actuation device for a sanitary fitting for the purpose of triggering a function, comprises a housing having a side face, and a sensor unit arranged at least partially in the housing having an emitter for emitting light waves and a receiver for detecting the light waves reflected by a user, a transmission region, through which the light waves can be delivered and the reflected light waves can be received, respectively, being arranged in the side face, and the actuation device furthermore comprising an optical unit, the optical unit being configured and arranged in such a way that the light waves from the emitter can be input into the optical unit and can be output from the optical unit at an angle as seen with respect to the horizontal through the transmission region.

### TECHNICAL FIELD

The present invention relates to an actuation device with user recognition.

### PRIOR ART

Actuation plates for user recognition are known from the prior art. For example, EP 3 031 989 discloses such an actuation plate, wherein sensors are arranged in a housing.

EP 2 497 868 discloses a further device for electrical triggering of water delivery, wherein the sensors monitor the space in front of the device through particular surface regions in the front face. The device according to EP 2 497 868 provides an efficient triggering device, but has the disadvantage that the production method for the front plate is very elaborate.

Practical use of such actuation plates has revealed that the functional reliability may be substantially dependent on the installation situation. Furthermore, false actuations often take place because persons who are merely going past the device, and are not interested in a triggering, are detected. Undesired phantom flushes occur.

### SUMMARY OF THE INVENTION

On the basis of this prior art, the object of the invention is to provide an actuation device having user recognition for the purpose of triggering a function, which overcomes the disadvantages of the prior art. It is a particularly preferred object to provide an actuation device which allows a more reliable user recognition.

This object is achieved by an actuation device for a sanitary fitting for the purpose of triggering a function in case of a recognized user. Accordingly, an actuation device according to the invention comprises a housing having a side face which extends substantially in a horizontal direction in the installation position, and a sensor unit arranged at least partially in the housing, having an emitter for emitting light waves and a receiver for detecting the light waves reflected by a user. The sensor unit is preferably an optoelectronic sensor unit. The light waves emitted by the emitter are reflected by the user when they strike the user and may be received again by the receiver. A transmission region, through which the light waves can be delivered and the reflected light waves can be received, respectively, is arranged in the region of the side face or in the side face, respectively. The actuation device furthermore comprises an optical unit, which is likewise at least partially arranged in the housing. The optical unit is configured and arranged in such a way that the light waves from the emitter can be input into the optical unit and can be output from the optical unit through the transmission region at an angle in the range of from 5° to 30°, in particular from 10° to 25°, as seen with respect to the horizontal. The reflected light waves can be input at an angle equal to said angle through the transmission region into the optical unit and can be output to the receiver.

The arrangement of the optical unit offers the advantage that the light waves can be emitted or received, respectively, at a comparably shallow angle with respect to the horizontal through the side face. By this beam path, the accuracy of the recognition of users may be improved significantly. False triggerings of the function on the sanitary fitting may be avoided by the improved recognition of the users.

Configuring the actuation device according to the description above offers the further advantage that the transmission region is placed on the sanitary fitting in such a way that during normal use, when a user is standing in front of the sanitary fitting, it cannot be seen directly. In this way, the sanitary fitting is configured to be more secured against vandalism attempts.

Furthermore, the arrangement of the sensor unit inside the housing is facilitated.

The arrangement of the transmission region in the side face offers further advantages:
Fouling: the transmission region in the side face is protected better against water splashes, fingerprints, etc.
Design freedom: by arranging the transmission region in the side face, a front face of the housing may be configured without restrictions. For example, surfaces with a very wide variety of materialisation, for example wood, stone, stainless steel, glass, etc. may be used, without the functionality being detrimentally affected.

The expression “housing” is intended to mean a structure which at least partially encloses the elements of the actuation device. The housing may be an integral part of a sanitary fitting, or it may be arranged separately from the sanitary fitting. The housing may in this case be a housing which is visible to the user. The housing may, however, also comprise housing parts which the user cannot see during normal use. One example of such housing parts is, for example, a frame which is mounted below the visible housing and which, if it represents an obstacle for the light waves, is likewise configured with a transmission region.

Preferably, the housing comprises a front face besides the side face. The side face in this case extends away from the front face substantially in the direction of the surface normal of the front face. In the installation position, the surface of the front face preferably lies in a vertical plane. With respect to the optical unit, it may also be stated that the optical unit is configured and arranged in such a way that the light waves from the emitter can be input into the optical unit and can be output from the optical unit at an angle in the range of from 5° to 30°, in particular from 10° to 25°, as seen with respect to the surface normal of the front face through the transmission region.

The expression “actuation device” is intended to mean a device which is used to trigger a sanitary function on a sanitary fitting. For example, the actuation device may be an actuation plate for triggering a flushing on a toilet or a urinal. The actuation device may also be a plate for an outlet fitting or a housing for a shower toilet or another sanitary device. The actuation device may be configured as the actual actuation plate. As an alternative, the actuation device may also be an integral part of the sanitary fitting or of another element which is used in a bathroom, for example a mirror cabinet, etc.

The expression “sanitary fitting” is intended to mean any sanitary fitting which is used in a bathroom. Examples which may be mentioned are a urinal, a toilet, a bidet, an outlet fitting, a shower head, etc.

If the actuation device is configured as an actuation plate, the housing is a rectangle or a square as seen looking at the front face in the direction of the surface normal, a side face extending from the front face in the direction of the surface normal of the edge of the rectangle or of the square, the transmission region being arranged in the region of the side face. Preferably, the extent of the side face in the direction of the surface normal is a multiple less than the extent of the front face transversely with respect to the surface normal.

For the user recognition, depending on the configuration of the sensor unit, the distance between the actuation device and the user to be recognized is preferably determined by means of triangulation. This means that a triangulation method is used for evaluating the emitted and received light waves. Other evaluation methods, for example a time-of-flight method, may however also be envisaged.

Preferably, the optical unit is configured with an emitter region for forwarding the light waves emitted by the emitter and with a receiver region for forwarding the reflected light waves to the receiver. The emitter region comprises an input face for input of the light waves from the emitter into the emitter region and an output face for output of the light waves from the emitter region. The receiver region comprises an input face for input of reflected light waves and an output face for output of light waves from the receiver region to the receiver.

Preferably, the output face of the emitter region and the input face of the receiver region lie in the transmission region of the side face. This means that the light waves of the emitter are guided outwards from the interior of the housing through the transmission region in the side face, and that the reflected light waves are guided inwards through the transmission region in the side face.

Preferably, according to a first variant, the optical unit comprises at least one optical prism having a reflection face, the light waves or the light waves reflected by the user being totally reflected at the reflection face, respectively. The optical prism provides a very simple means for deviating the light beams according to the angles described above. According to a second variant, the optical unit comprises a mirror having a reflection face, the light waves or the light waves reflected by the user being totally reflected at the reflection face, respectively.

The reflection face of a prism and minor is preferably inclined at an angle with respect to the horizontal and the vertical. The angle is dependent on the arrangement of the emitter and the receiver.

In respect of the configuration of the emitter region and the receiver region on the optical unit, or on the optical prism, different variants may be envisaged as will be described below.

In a first variant, the emitter region and the receiver region are implemented on a single optical unit. This variant has the advantage of a simple structure.

In a second variant, the emitter region and the receiver region are implemented on a single optical unit having an opaque separating layer. The opaque separating layer is configured to be opaque for the light waves. By this configuration, crosstalk from the emitter region into the receiver region and vice versa may be substantially avoided.

In a third variant, the emitter region and the receiver region are respectively implemented on one of two optical units arranged separated from one another. The division between two different optical units offers the advantage of greater configurational freedom.

Preferably, the output face of the emitter region, through which the light beam from the emitter is output, is provided with at least one surface structure. The surface structure is configured in such a way that reflection losses can be reduced. As an alternative or in addition, the input face of the receiver region, through which the reflected light beam is input, is provided with at least one surface structure which is configured in such a way that reflection losses can be reduced.

By said surface structure, the output face or the input face, respectively, may be optimized in such a way that shallower angles can be achieved, because total reflection may be avoided by the surface structure.

The surface structure may be configured in various ways. Three particularly preferred embodiments are explained in more detail below

According to a first embodiment, the surface structure is an antireflection coating, the antireflection coating comprising at least one dielectric layer or a plurality of dielectric layers above one another.

According to a second embodiment, the surface structure is a diffractive layer, the diffractive layer preferably consisting of a periodic grating, the grating spacing being in the range of from 75 to 125 nanometres, in particular 100 nanometres.

According to a third embodiment, the surface structure comprises a lens structure, the lens structure preferably being provided by Fresnel lenses having steps.

The steps are preferably arranged in such a way that shadowing of the individual steps cannot occur.

In one preferred refinement of the third embodiment, the lens structure is coated with an antireflection coating, the antireflection coating comprising at least one dielectric layer or a plurality of dielectric layers above one another. In another preferred refinement of the third embodiment, the lens structure may be coated with a diffractive layer, the diffractive layer preferably consisting of a periodic grating, the grating spacing being in the range of from 75 to 125 nanometres, in particular 100 nanometres.

In a first variant, the transmission region is provided by an opening in the side face, the output face of the emitter region and the input face of the receiver region respectively being substantially flush with the side face in which the opening is arranged

In a second variant, the transmission region is provided by a subregion in the side face which is configured to be transparent for the light beam from the emitter and for the reflected light beam. The output face of the emitter region and the input face of the receiver region then respectively lie outside the housing as seen from behind the transparent subregion.

In both variants, the transmission region lies in a side face of the housing, as explained in the introduction.

Preferably, the transmission region as seen in the installation position lies on the side face of the housing, which is oriented downwards.

Preferably, the optoelectronic sensor unit is an infrared sensor having an infrared emitter and an infrared receiver, the wavelength of the light waves being in the range of from 780 to 1000 nanometres. If other optoelectronic sensor units are used, the wavelength range of the light waves may be in the range of from 400 to 1550 nanometres.

An arrangement comprises an actuation device according to the description above and a sanitary fitting, the transmission region being directed towards the sanitary fitting in the installation position; and/or the transmission region being directed downwards in the installation position. In this context, downwards means towards the floor, in which case the light waves may be emitted at a shallow angle with respect to the horizontal according to the description above.

### BRIEF DESCRIPTION OF THE DRAWINGS

Preferred embodiments of the invention are described below with the aid of the drawings, which serve merely for explanation and are not to be interpreted restrictively. In the drawings:

FIG. 1 shows a schematic view of an installation situation of one embodiment of the actuation device with one variant of a sanitary fitting;

FIG. 2 shows a schematic view of the actuation device according to FIG. 1 from below;

FIG. 3a shows a schematic sectional view of the actuation device according to FIG. 1 with the emitter unit;

FIG. 3b shows a schematic sectional view of the actuation device according to FIG. 1 with the receiver unit;

FIG. 4a shows a first refinement of the actuation device according to the preceding figures;

FIG. 4b shows a second refinement of the actuation device according to the preceding figures; and

FIG. 4c shows a third refinement of the actuation device according to the preceding figures.

### DESCRIPTION OF PREFERRED EMBODIMENTS

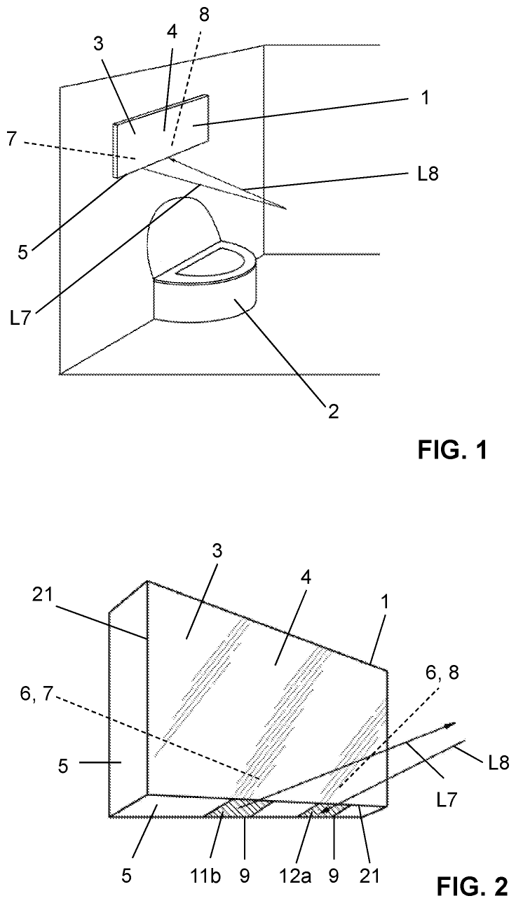

FIG. 1 shows a schematic view of a bathroom. An actuation device 1 according to a preferred embodiment of the present invention is arranged in the bathroom. A function on a sanitary fitting 2 can be triggered with the actuation device 1. In the embodiment shown, the sanitary fitting 2 is a toilet and the function which is triggered by the actuation device 1 is the flushing of the toilet. As explained below, the actuation device 1 is configured in such a way that light waves L7 are emitted by an emitter 7 and the light waves L8 reflected by a user can be detected again by a receiver 8. In this way, the user can be recognized as such and the function can be triggered, or alternatively the distance to the user may be measured so that the distance to the sanitary fitting 2 can be determined, the function then being triggered on the basis of the distance.

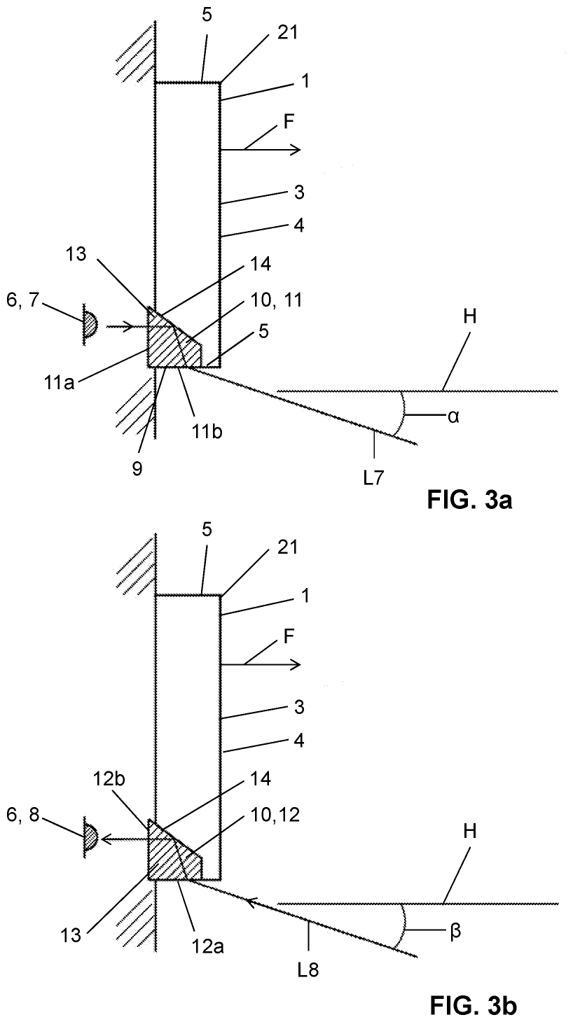

FIG. 2 shows a preferred embodiment of the arrangement of the emitter 7 and the receiver 8. The emitter 7 and the receiver 8 are in this case arranged in such a way that the light waves L7 are emitted by the emitter 7 and the light waves L8 are received by the receiver 8, respectively, through a side face 5 of the actuation device 1. In the embodiment shown, the side face 5 is along the horizontal and is directed towards the sanitary fitting 2. The light waves L7, L8 are, as described in detail below, emitted angularly inclined at a shallow angle with respect to the surface normal F of the front face 4 of the housing 3.

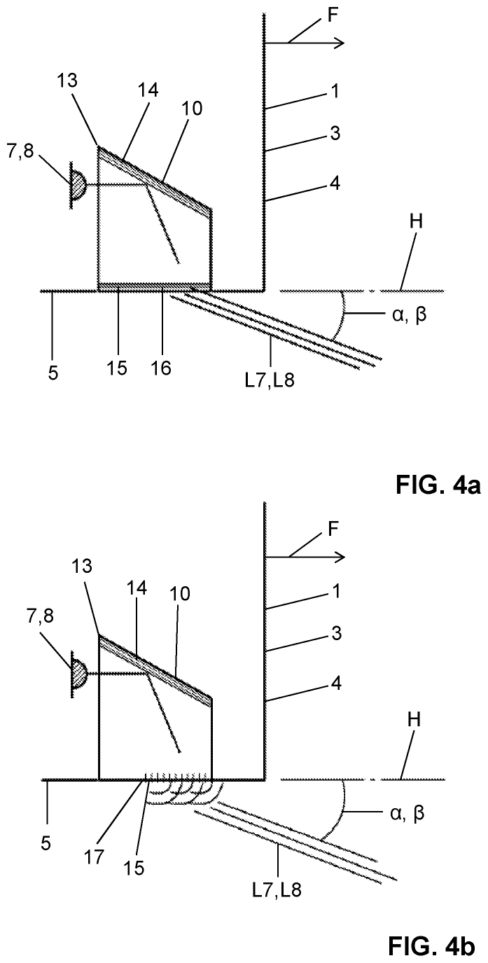

The actuation device 1 will now be described in more detail with reference to FIGS. 2 and 3a and 3b.

As mentioned, the housing 3 comprises a front face 4 and a side face 5. As shown in the figures, the side face 5 of the housing 3 extends away from the front face 4 in the direction of the surface normal F of the front face 4. The side face 5 in this case extends rearwards away from each side edge 21 of the front face 4. In the installation position, the side faces 5 are exposed. This means that the side faces 5 are not covered by parts of the building, such as brickwork, tiles, etc. The front face 4 is preferably configured to be optically opaque.

The actuation device 1 furthermore comprises a sensor unit 6, arranged at least partially in the housing 3, having an emitter 7 for emitting light waves L7 and a receiver 8 for detecting the light waves L8 reflected by a user. The emitter 7 and the beam path of the light waves L7 from the emitter 7 out of the housing 3 are represented in FIG. 3a. The receiver 8 and the beam path of the light waves L8 into the housing 3 to the receiver 8 are represented in FIG. 3b.

Arranged in the region of the side face 5 or in the side face 5 itself, there is a transmission region 9 through which the light waves L7 can be emitted and through which the reflected light waves L8 can be received, respectively. The corresponding light waves L7, L8 can respectively be sent out of and into the housing 3 through this transmission region 9.

It is shown by FIGS. 3a and 3b that the actuation device 1 furthermore comprises an optical unit 10. The optical unit 10 is in this case configured and arranged in such a way that the light waves L7 from the emitter can be input into the optical unit 10 and can be output from the optical unit 10 angularly inclined at an angle α with respect to the surface normal F of the front face 4 through the transmission region 9. The optical unit 10 is furthermore configured and arranged in such a way that the light waves L8 can be input into the optical unit 10 angularly inclined at an angle β with respect to the surface normal F of the front face 4 and can be output from the optical unit 10 to the receiver 8. The angle α and the angle β are preferably in the range of from 5° to 30°, particularly in the range of from 10° to 25°, with respect to the surface normal F of the front face 4.

Inside the housing 3, the light waves L7, L8 are guided again in the direction of the surface normal F. In other variants, it would also be conceivable to guide the light waves L7, L8 in a different direction, in particular angularly inclined with respect to the surface normal F.

As seen in the installation position, the front face 4 typically lies along the vertical and the surface normal F accordingly lies along the horizontal H. The angle α or the angle (3, respectively, in this case substantially extends downwards from the horizontal H.

The optical unit 10 comprises an emitter region 11 and a receiver region 12. From the emitter 7, the light waves L7 are input into an input face 11a into the emitter region 11, and the light waves L7 are output again from the emitter region 11 through an output face 11b. The receiver region 12 is configured to be substantially identical to the emitter region 11. The receiver region 12 comprises an input face 12a for input of the reflected light waves L8 and an output face 12b for output of the light waves L8 from the receiver region 12 to the receiver 8.

The output face 11b of the emitter region 11 and the input face 12a of the receiver region 12 lie in the transmission region 9 of the side face 5. The output face 11b and the input face 12a are positioned in such a way that the light waves L7 and L8 can respectively be output and input in the direction described above. The transmission region is preferably an opening 21 in the side face 5. This means that the output face 11b of the emitter region 11 and the input face 12a of the receiver region 12 respectively lie in the opening 21. Particularly preferably, the output face 11b and the input face 12a are flush with the side face 5. In another embodiment not shown in the figures, the transmission region may also be provided by a subregion in the side face 5, which is configured to be transparent.

The emitter region 11 and the receiver region 12 may be implemented on a single optical unit 10, or alternatively on two optical units 10 arranged separately from one another. In the case of the single optical unit 10, it is furthermore conceivable for the emitter region 11 and the receiver region 12 to be separated from one another by an opaque separating layer. In this way, crosstalk between the emitter region 11 and the receiver region 12 can be prevented.

In the embodiment shown, the optical unit 10 is an optical prism 13 having a reflection face 14. The emitter region 11 and the receiver region 12 may in this case be arranged on the same prism or on different prisms. As is shown by FIG. 3a and FIG. 3b, the light waves L7 and the light waves L8 reflected by the user, respectively, are totally reflected at the reflection face 14. In the embodiment shown, the light waves L7 strike the input face 11a of the emitter region 11 from the emitter 7 in the direction of the surface normal F, and are correspondingly reflected by the reflection face 14. Subsequently, the light waves L7 are then output again through the output face 11b of the emitter region 11 of the optical prism 13. The output takes place at the angle α described above. The light waves L8 strike the input face 12b in the direction of the angle b and are input into the optical prism 13. The light waves L8 are totally reflected at the reflection face 14, and then output from the output face 12b in the direction of the surface normal F to the receiver 8.

Instead of an optical prism, the optical unit may also comprise other optical elements which deviate the light waves L7, L8 correspondingly.

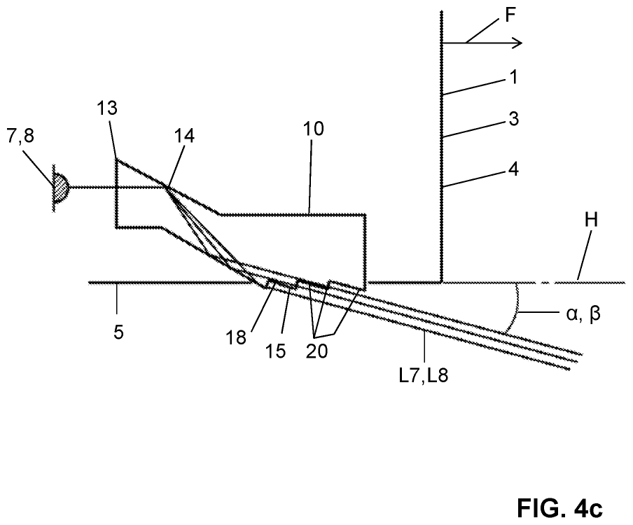

The output face 11b, through which the light beam L7 is output from the emitter 7, of the emitter region 11 may, as shown by FIGS. 4a to 4c, be provided with at least one surface structure 15. Likewise, the input face 12a, through which the reflected light beam L8 is output, of the receiver region 12 may be provided with at least one surface structure 15. The surface structures 15 are in this case configured in such a way that reflection losses can be reduced. Three different embodiments of the surface structure 15 are described in more detail below, these embodiments being usable both for the output face 11b of the emitter region and for the input face 12a of the receiver region 12.

FIG. 4a shows the surface structure 15 according to a first embodiment. According to this first embodiment, the surface structure 15 is an antireflection coating 16. The antireflection coating 16 is preferably at least one dielectric layer, or a plurality of dielectric layers above one another. By means of such layers, the reflection behaviour in the region of the output face 11a or of the input face 12a may respectively be improved. In this way, an angle α which is as small as possible is achieved.

According to the second embodiment of FIG. 4b, the surface structure 15 is a diffractive layer 17. The diffractive layer 17 preferably consists of a periodic grating. The grating spacing in the periodic grating is in the range of from 75 to 125 nanometres, in particular 100 nanometres. The diffractive layer 17 also has the advantage that an angle α which is as small as possible is achieved.

FIG. 4b shows a third embodiment of the surface structure 15. In this case, the surface structure 15 is a lens structure 18. Preferably, the lens structure 18 is provided with Fresnel lenses 19 having corresponding steps 20. The steps 20 are in this case configured in such a way that the light beam can emerge several times from each lens, the individual Fresnel lenses 19 not shadowing one another.

The lens structure 18 may furthermore be coated with the antireflection coating 16 according to the first embodiment or alternatively with a diffractive layer 17 according to the second embodiment. In this way, the exit results of the light waves L7 and the entry results of the light waves L8 may be further improved.

The optoelectronic sensor unit 6 is preferably an infrared sensor with an infrared emitter and an infrared receiver. The infrared emitter is in this case the emitter 7 mentioned herein and the infrared receiver is the receiver 8 mentioned herein. Other electronic sensors are also possible.

### LIST OF REFERENCES

1 actuation device 17 diffractive layer
2 sanitary fitting 18 lens structure
3 housing 19 Fresnel lenses
4 front face 20 steps
5 side face 21 side edge
6 sensor unit
7 emitter α angle
8 receiver β angle
9 transmission region
10 optical unit F surface normal
11 emitter region H horizontal
11a input face
11b output face L7 light waves from the emitter
12 receiver region L8 light waves to the receiver
12a input face
12b output face
13 optical prism
14 reflection face
15 surface structure
16 antireflection coating

1-14. (canceled)

15. An actuation device for a sanitary fitting for the purpose of triggering a function, in case of a recognized user, comprising:
a housing having a side face which extends substantially in a horizontal direction in the installation position, and
a sensor unit arranged at least partially in the housing, having an emitter for emitting light waves and a receiver for detecting the light waves reflected by a user,
wherein a transmission region, through which the light waves can be delivered and the reflected light waves can be received, respectively, is arranged in the region of the side face or in the side face,
wherein the actuation device furthermore comprises an optical unit, the optical unit being configured and arranged in such a way that the light waves from the emitter can be input into the optical unit and can be output from the optical unit at an angle in the range of from 5° to 30°, in particular from 10° to 25°, as seen with respect to the horizontal through the transmission region, and
wherein the reflected light waves being capable of being input at an angle equal to said angle through the transmission region into the optical unit and of being output to the receiver.

16. The actuation device according to claim 15, wherein said sensor unit is an optoelectronic sensor unit.

17. The actuation device according to claim 15, wherein the optical unit is configured with an emitter region for forwarding the light waves emitted by the emitter and with a receiver region for forwarding the reflected light waves to the receiver,
the emitter region comprising an input face for input of the light waves from the emitter into the emitter region and an output face for output of the light waves from the emitter region, and
the receiver region comprising an input face for input of reflected light waves and an output face for output of light waves from the receiver region to the receiver.

18. The actuation device according to claim 17, wherein the output face of the emitter region and the input face of the receiver region lie in the transmission region of the side face.

19. The actuation device according to claim 15, wherein the optical unit comprises at least one optical prism having a reflection face, the light waves or the light waves reflected by the user, respectively, being totally reflected at the reflection face.

20. The actuation device according to claim 15, wherein the optical unit comprises a mirror having a reflection face, the light waves or the light waves reflected by the user, respectively, being totally reflected at the reflection face.

21. The actuation device according to claim 17,
wherein the emitter region and the receiver region are implemented on a single optical unit); or
wherein the emitter region and the receiver region are implemented on a single optical unit having an opaque separating layer between emitter region and receiver region; or
wherein the emitter region and the receiver region are respectively implemented on one of two optical units arranged separated from one another.

22. The actuation device according to claim 15,
wherein the optical unit is configured with an emitter region for forwarding the light waves emitted by the emitter and with a receiver region for forwarding the reflected light waves to the receiver,
the emitter region comprising an input face for input of the light waves from the emitter into the emitter region and an output face for output of the light waves from the emitter region, and
the receiver region comprising an input face for input of reflected light waves and an output face for output of light waves from the receiver region to the receiver,
wherein the output face of the emitter region, through which the light beam from the emitter is output, is provided with at least one surface structure which is configured in such a way that reflection losses can be reduced; and/or
wherein the input face of the receiver region, through which the reflected light beam is input, is provided with at least one surface structure which is configured in such a way that reflection losses can be reduced.

23. The actuation device according to claim 22, wherein the surface structure is an antireflection coating, the antireflection coating comprising at least one dielectric layer or a plurality of dielectric layers above one another.

24. The actuation device according to claim 22, wherein the surface structure is a diffractive layer, the diffractive layer preferably consisting of a periodic grating, the grating spacing being in the range of from 75 to 125 nanometres, in particular 100 nanometres.

25. The actuation device according to claim 22, wherein the surface structure comprises a lens structure, the lens structure preferably being provided by Fresnel lenses having steps.

26. The actuation device according to claim 25, wherein the lens structure is coated with an antireflection coating, the antireflection coating comprising at least one dielectric layer or a plurality of dielectric layers above one another; and/or wherein the lens structure is coated with a diffractive layer, the diffractive layer preferably consisting of a periodic grating, the grating spacing being in the range of from 75 to 125 nanometres, in particular 100 nanometres.

27. The actuation device according to claim 15, wherein the transmission region is provided by an opening in the side face, the output face of the emitter region and/or the input face of the receiver region being substantially flush with the side face in which the opening is arranged.

28. The actuation device according to claim 15, wherein the transmission region is provided by a subregion in the side face which is configured to be transparent for the light beam from the emitter and for the reflected light beam.

29. The actuation device according to claim 15, wherein the transmission region as seen in the installation position lies on the side face, which is oriented downwards.

30. The actuation device according to claim 15, wherein the sensor unit is an optoelectronic sensor unit comprising an infrared sensor having an infrared emitter and an infrared receiver, the wavelength of the light waves being in the range of from 780 to 1000 nanometres.

31. The actuation comprising an actuation device according to claim 15 and a sanitary fitting, the transmission region being directed towards the sanitary fitting in the installation position.
